(19) United States
(12) Patent Application Publication
(10) Pub. No.: US 2006/0117861 A1
(43) Pub. Date: Jun. 8, 2006

(54) Material tester

(76) Inventor: Noriaki Komine, Kyoto-shi (JP)

Correspondence Address: J.C. Patents, Suite 250, 4 Venture, Irvine, CA, 92618, US

(21) Appl. No.: 11/288,727

(22) Filed: Nov. 28, 2005

(30) Foreign Application Priority Data
Dec. 2, 2004 (JP) JP2004-349786

(51) Int. Cl. F16B 31/02

(52) U.S. Cl. 73/761

(57) ABSTRACT

A material tester using a connection structure is provided. A shaft carved with a male thread on a root of the shaft is formed with a fixture, and a lock nut is screwed against the male thread. A connection component formed with a hole for embedding the shaft is fixed on a loading component (table). In a state that a pin is inserted into lateral holes formed in the shaft and the connection component, gaps between the pin and the lateral holes are eliminated by fastening the lock nut. In addition, by forming a taper portion and a taper hole respectively en the lock nut and in the hole of the connection component, the taper portion is complementally engaged with the taper hole during fastening the lock nut, so as to center on the fixture. Therefore, the fixture can be always connected to the connection component in a preset position.

### CROSS-REFERENCE TO RELATED APPLICATION

This application claims the priority benefit of Japan application serial no. JP2004-349786, filed on Dec. 2, 2004. All disclosure of the Japan application is incorporated herein by reference.

### BACKGROUND OF THE INVENTION

1. Field of Invention

The present invention relates to a material tester. More particularly, the present invention relates to a material tester for a test piece wherein the test piece is loaded in a manner that both ends of a test piece are held by a pair of fixtures installed on a loading structure.

2. Description of Related Art

In a material tester for performing a tensile test of materials, a loading structure having a pair of loading components is usually employed. The pair of loading components can be displaced relatively toward or away from each other. A loading is exerted to a test piece by driving the loading structure in a manner that both ends of the test piece W are held by fixtures that are respectively installed on each loading component.

FIG. 3 exemplifies the structure of the main components of such a material tester. In the example, two threaded rods 72a, 72b capable of rotating freely are disposed on a table 71. Two end parts of a crosshead 73 are supported on the two thread rods 72a, 72b by using nuts (not shown). By rotationally driving the thread rods 72a, 72b using a driving device 74, the crosshead 73 moves toward or away from the table 71. The table 71 and the crosshead 73 correspond to the aforementioned loading components. Furthermore, fixtures 75a, 75b are installed on the table 71 and the crosshead 73 respectively. The test piece W is applied with a tensile loading by for example raising the crosshead 73 having the two ends of the test piece W respectively held by the fixtures 75a, 75b (for example, refer to Japanese Patent Publication 2002-250682). Furthermore, the upper fixture 75b is not directly installed on the crosshead 73; instead the upper fixture 75b is more frequently installed on a load cell 76 fixed on the crosshead 73 as shown in FIG. 3.

In such a material tester, regarding the connection structures between the fixture 75a, and the table 71 and between the fixture 75b and the crosshead 73 (load cell 76), FIG. 4 exemplary illustrates the major components of a connection structure between the lower fixture 75a and the table 71 in a cross-sectional view. Namely, a shaft 81 is formed within or inserted into the fixture 75a and male thread 81a is carved at the root of the shaft 81. In addition, a connection component 82 where a hole 82a for embedding the shaft 81 is formed therein is fixed on the table 71. In a state that the shaft 81 is embedded into the hole 82a of the connection component 82, a pin 83 is inserted into both the lateral holes 81b, 82b respectively formed in the shaft 81 and the connection component 82. With this configuration, a lock nut 84 screwed into the male thread 81a is fastened downwards (with respect to the drawing) and the shaft 81 is drawn upwards accordingly. In this manner, gaps between the pin 83 and the lateral holes 81b, 82b are eliminated and thus the fixture 75a and the connection component 82 are fastened together. By using such a connection structure, the pin 83 undertakes a force that acts on the fixture 75a in the test.

Furthermore, the connection structure between the upper fixture 75b and the load cell 76 is fundamentally the same as the aforementioned structure. Mostly, the structure of FIG. 4 without the lock nut 84 is usually adopted.

However, in the aforementioned material tester, it is very important for performing a correct test that axes of the upper and lower fixtures have to be aligned. For example, a bending stress is exerted on the test piece during a tensile test, if the axes are misaligned; a correct result for the tensile test cannot be obtained.

In the conventional structure as shown in FIG. 4, the axis of the lower fixture 75a can be aligned with the axis of the upper fixture 75b by adjusting the position of the connection component 82 with respect to the table 71.

In a case, the fixture 75a is removed and other fixture is used, and the original fixture 75a is reinstalled subsequently. However, once the fixture 75a is removed from the connection component 82, a gap is formed between the shaft 81 and the hole 82a; therefore the axes are no longer aligned. As a result, the position of the connection component 82 must be adjusted again to align the axes.

### SUMMARY OF THE INVENTION

According to above description, the present invention is to provide a material tester, wherein the installation position of the fixture with respect to the connection component can be maintained without any change. Furthermore, even though the fixtures are removed and reinstalled, the axes of the upper and lower fixture can be aligned without deviation.

Accordingly, the present invention provides a material tester including a loading structure. The loading structure includes a pair of loading components, wherein the loading components can approach or be apart from each other, and each loading component has a fixture installed thereon. The material tester provides a loading to a test piece by driving the loading structure in a state that both ends of the test piece are respectively held by the fixtures. The material tester further includes a connection structure for connecting the fixture and at least one of the loading components, and a shaft carved with a male thread on a root of the shaft is formed or inserted in the fixture. A connection component is fixed at the loading component side and has a hole formed therein for accommodating the shaft. A pin is inserted into lateral holes respectively formed within the shaft and the connection component in a state that the shaft is embedded into the hole of the connection component, so that gaps formed between the pin and the lateral holes can be eliminated by fastening a lock nut against the male thread, and the fixture and the connection component are fastened together. In addition, the hole of the connection component is formed with a taper opening in which the size of the opening increases outwardly relative to the bottom of the hole, and the lock nut is formed with a taper portion which complementally engages with the tapering opening.

In the above material tester, when the shaft of the fixture is fastened by the lock nut to the connection component, the shaft is also centered by the lock nut. Accordingly, the above problem can be solved.

Namely, when the shaft of the fixture is inserted into the hole of the connection component and the pin is inserted through the shaft and the connection component followed by fastening the lock nut against the male thread formed on the shaft of the fixture, the taper portion of the lock nut is embedded into the taper hole formed at the opening of the hole of the connection component so that the lock nut is centered on the shaft. The lock nut is screwed against the male thread of the shaft of the fixture to engage with the shaft. Accordingly, the shaft of the fixture is centered in the hole of connection component; and therefore, the fixture can be always connected to the connection component in a preset position.

According to the present invention, the fixture is connected through the connection component to the loading component of the loading structure, and the fixture is always connected to the connection component with a preset position relation when installing the fixture to the connection component. After the axes of the upper and lower fixtures are aligned to adjust the position of the connection component, the axes of the upper and lower fixtures will not deviate even though the fixtures are removed and reinstalled.

### BRIEF DESCRIPTION OF THE DRAWINGS

FIG. 1 is a cross sectional view showing the structure of main components of a lower fixture according to one embodiment of the present invention.

FIG. 2 is a cross sectional view showing the structure of main components of a lower fixture before the fastening of the lock nut according to one embodiment of the present invention.

FIG. 3 illustrates an example of the structure of main components of a conventional material tester.

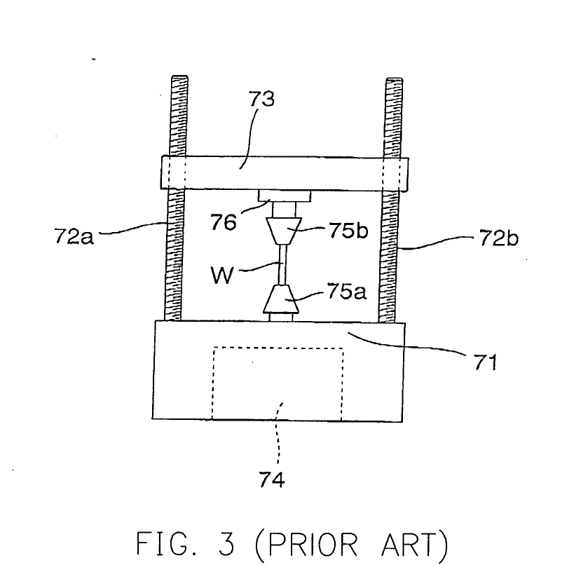

FIG. 4 is a cross sectional view showing an example of a connection structure for a fixture and a loading component according to a conventional material testers.

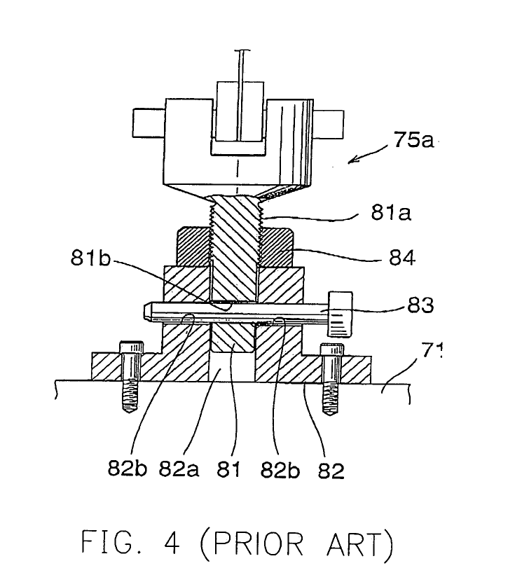

### DESCRIPTION OF EMBODIMENTS

Embodiments of the present invention are described hereinafter with reference to the drawings.

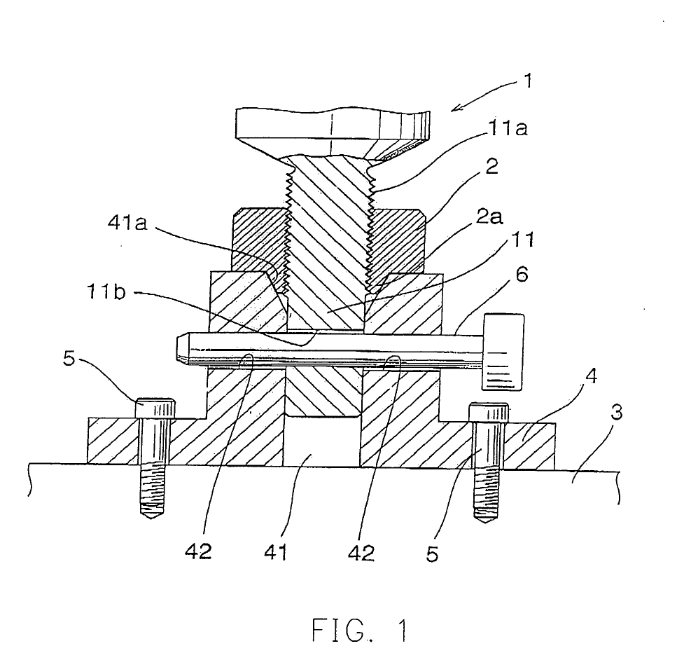

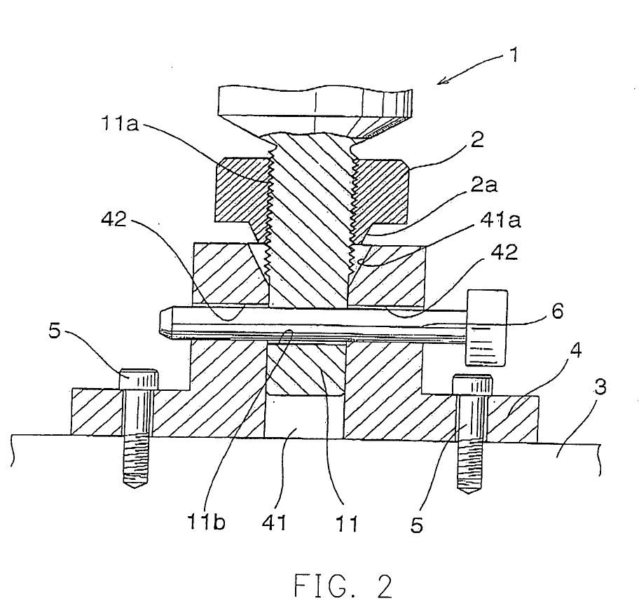

FIG. 1 is a cross sectional view showing the structure of main components of a lower fixture applicable to one embodiment of the present invention. FIG. 2 is a cross sectional view showing the structure of main components of a lower fixture before the fastening of the lock nut 6.

A shaft 11 is formed to protrude from or insert into a fixture 1, male thread 11a is carved on the root of the shaft 11. A lock nut 2 is screwed into the male thread 11a, and a taper portion 2a with a diameter tapering toward its lower side is formed to protrude from the lower surface of the lock nut 2. Furthermore, a lateral hole 11b is formed in the shaft 11 to penetrate the shaft 11 along a direction perpendicular to the shaft axis. A connection component 4 is fixed by a bolt 5 onto a table 3, and a hole 41 for embedding the shaft 11 of the fixture 1 is formed within the connection component 4. The hole 41 has a taper opening 41a. The diameter of the taper opening 41a increases toward the upper side of the hole 41, and the taper angle of the taper hole 41a and the taper portion 2a of the lock nut 2 are the same. Furthermore, a lateral hole 42 is also formed in the connection component 4 to penetrate the connection component 4 along a direction perpendicular to the axis of the hole 41. A pin 6 is inserted through the lateral hole 42 of the connection component 4 and the lateral hole 11b of the shaft 11.

When the fixture 1 is connected to the connection component 4, as shown in FIG. 2, the shaft 11 of the fixture 1 is embedded in the hole 41 of the connection component 4 such that the pin 6 is inserted through the lateral hole 11b of shaft 11 and the lateral hole 42 of connection component 4. Furthermore, the lock nut 2 is fastened downward against the male thread 11a. After the lock nut 2 is in contact with the upper part of the connection component 4, the shaft 11 is pulled up and the pin 6 penetrating through the lateral hole 11b is lifted. As a result, as shown in FIG. 1, the pin 6 presses the lower part of the lateral hole 11b of the shaft 1, and also presses the upper part of the lateral hole 42 of connection component 4. Therefore, the gaps between the pin 6 and the lateral holes 11b, 42 are eliminated, and the fixture 1, the connection component 4 are fastened to the table 3.

Thus, when the lock nut 2 is fastened downward against the male thread 11a in the above connecting movement, the taper portion 2a formed below the lock nut 2 is embedded in the taper opening 41a of the connection component 4, and the lock nut 2 is centered in the hole 41 of the connection component 4. Therefore, since the shaft 11 of the fixture 1 is fastened by the lock nut 2 to the connection component 4, the fixture 1 and the lock nut 2 are centered in the connection component 4.

According to the embodiment of the present invention, when the fixture 1 is installed onto the connection component 4, the fixture 1 is always installed onto the connection component 4 at a fixed position. Accordingly, after the position of the connection component 4 with respect to the table 3 is adjusted and the axes of the upper and the lower fixtures are aligned, the alignment of the axes is not shifted even if the fixture 1 is removed and reinstalled.

Furthermore, the aforementioned embodiment discloses an example that the present invention is applied to the lower fixture. However, according to the configuration of the material tester, the present invention can be only applied to the upper fixture, or can be applied to both of the upper and lower fixtures.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A material tester, comprising a loading structure including a pair of loading components that displace relatively from each other by moving toward or away from each other, and each loading component having a fixture installed thereon, wherein the material tester provides a loading to a test piece by driving the loading structure having both ends of the test piece respectively held by the fixtures, and wherein the material tester comprises a connection structure for connecting the fixture and at least one of the loading components, a shaft carved with a male thread on a root of the shaft is formed or inserted in the fixture;
a connection component is fixed at the loading component side and has a hole formed therein for accommodating the shaft;
a pin is inserted into lateral holes respectively formed within the shaft and the connection component in a way that the shaft is embedded in the hole of the connection component, so that gaps between the pin and the lateral holes are eliminated by fastening a lock nut against the male thread to fasten the fixture and the connection component together; and
a taper opening of the hole of the connection component is formed with a diameter that increases outwardly relative to a bottom of the hole, and a taper portion is formed on the lock nut, wherein the taper portion complementally engages with the taper opening.

2. The material tester according to claim 1, wherein the connection component is fixed by bolts.

3. The material tester according to claim 1, wherein tapered angles of the taper opening and the taper portion are the same.

4. The material tester according to claim 1, wherein each of the lateral holes is arranged along a direction perpendicular to the axis of the shaft.
